(19) United States
(12) Patent Application Publication
(10) Pub. No.: US 2025/0259563 A1
(43) Pub. Date: Aug. 14, 2025

(54) METHOD AND SYSTEM FOR SECURE ONLINE EVALUATION

(71) Applicant: CENTRE DE FORMATION PROFESSIONNELLE DU FLEUVE-ET-DES-LACS, Témiscouata-sur-le-lac (CA)

(72) Inventor: Frédéric CASTONGUAY, Matane (CA)

(21) Appl. No.: 19/172,795

(22) Filed: Apr. 8, 2025

Related U.S. Application Data
(60) Provisional application No. 63/551,706, filed on Feb. 9, 2024.

(51) Int. Cl. G09B 7/02; G06Q 50/20; G06V 20/52; G06V 40/10

(52) U.S. Cl. CPC G09B 7/02; G06Q 50/20; G06V 20/52; G06V 40/10

(57) ABSTRACT

A computer-implemented method for an online student assessment includes: using a server computer for: gaining access to an information processing apparatus; the information processing apparatus having an output device, a camera, and at least one input device; identifying processes running on the information processing apparatus; stopping the processes on the information processing apparatus that have been determined as being unallowed during the online student assessment; verifying an identity of a user of the student computer; if the identity of the user is confirmed then, while remotely monitoring the user via the camera, displaying questions on the display monitor, and receiving answers via the at least one input device; restarting at least one of the unallowed processes; and restoring access to the student computer.

### CROSS-REFERENCE TO RELATED APPLICATIONS

This application claims the benefit of U.S. Provisional Application No. 63/551,706, filed on Feb. 9, 2024. The entire disclosure of the above application is incorporated herein by reference.

### FIELD

The disclosure generally relates to online evaluations. More specifically, the disclosure relates to systems for secure online evaluations.

### INTRODUCTION

This section provides background information related to the present disclosure which is not necessarily prior art.

Many computer-based systems for online evaluations are known. They include providing a web-based or downloadable questionnaire and safety mechanisms of different levels for protection against cheating.

For example, some of such systems require that the students yield access to their computer's camera and microphone to a remote supervisor. Also, some systems allow students accessing a secure web page that includes the questionnaire and cause the evaluation cession to permanently stop as soon as the student quits the page, for example to open another tab of their web browser.

It has been found that known computer-based systems for online evaluations leave some freedom to the students and are based on a high level of confidence in the honesty thereof and/or required the simultaneous use of many applications.

### SUMMARY

According to illustrative embodiments, there is provided a computer-implemented method for an online student assessment comprising:
using a server for:
gaining access to a student information processing apparatus; the information processing apparatus comprising at least one output device, a camera, and at least one input device;
identifying processes running on the information processing apparatus;
among the processes running on the information processing apparatus, stopping processes determined to be unallowed during the online student assessment;
verifying an identity of a user of the information processing apparatus;
if the identity of the user is confirmed then, while remotely monitoring the user via the camera, providing questions on the at least one output device, and receiving answers via the at least one input device;
restarting at least one of the unallowed processes; and
restoring access to the information processing apparatus.

According to another illustrative embodiment, there is provided a server having access to at least one computer-readable memory having recorded thereon at least one student evaluation; the server being configured for gaining access to at least one information processing apparatus via instructions for execution on the at least one information processing apparatus; the at least one information processing apparatus including at least one output device, a camera, and at least one input device; the instructions being for:
identifying processes running on the at least one information processing apparatus;
among the processes running on the at least one information processing apparatus, stopping processes determined to be unallowed during the online student assessment;
verifying an identity of a user of the at least one information processing apparatus using the camera;
if the identity of the user is confirmed then, while remotely monitoring the user via the camera, providing questions on the at least one output device, and receiving answers via the at least one input device;
restarting at least one of the unallowed processes; and
restoring access to the at least one information processing apparatus.

According to yet another illustrative embodiment, there is provided a non-transitory computer-readable medium having recorded thereon instructions for execution by an information processing apparatus equipped with at least one output device, a camera, and at least one input device; the instructions being for:
identifying processes running on the information processing apparatus;
stopping the processes running on the information processing apparatus that have been determined as being unallowed;
allowing a remote device to use the camera, and to access information about the students to verify an identity of a user of the information processing apparatus;
if the identity of the user is confirmed then, while remotely monitoring the user via the camera, providing questions on the at least one output device and receiving answers via the at least one input device;
restarting at least one of the unallowed processes; and
restoring access to the information processing apparatus.

It is to be noted that the term ‘student’ should be construed in the description and in the claims as including any person having or wishing to pass an evaluation.

The term ‘memory’ should be construed broadly as including any volatile or non-volatile storage capable of storing computer-readable data.

The terms ‘evaluation’ and ‘assessment’ will be used herein interchangeably as to mean any number of questions in some form, including texts, graphics, or sounds and any combination thereof.

The term “information processing apparatus” should be construed in the description and in the claims as including any device or system capable of performing operations on data, which may include general-purpose computers, specialized hardware, such as embedded systems, distributed computing architectures, smartphones, personal computers (PC), etc.

The term “non-transitory computer-readable medium” should be construed in the description and in the claims as including any tangible storage device capable of storing computer-executable instructions, data, or software for use by a computer processor.

The term ‘server’ should be construed in the description and in the claims as including any computing device, system, or distributed architecture configured to provide processing, storage, management, or communication services to other devices, systems, or users over a network, and can be implemented in hardware, software, or a combination thereof so as to operate in local, cloud-based, or virtualized environments.

Other objects, advantages, and features of a method and system for secure online evaluation will become more apparent upon reading the following non-restrictive description of illustrative embodiments thereof, given by way of example only with reference to the accompanying drawings.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of a system for secure online evaluation according to an illustrative embodiment;

FIG. 2 is a flow chart of a computer-implemented method for secure online evaluation according to an illustrative embodiment;

FIG. 3 is a schematic view illustrating a prompting window within the Windows™ environment, allowing a student to enter its credentials, as a step towards establishing a student-server connection as part of the method of FIG. 2;

FIG. 4 is a schematic view of an interactive graphical user interface displayed on students display monitors, as part of system from FIG. 1; and

FIG. 5 is a schematic view of an interactive graphical user interface displayed on a supervisor monitor, as part of system from FIG. 1.

### DETAILED DESCRIPTION

It should be understood that the elements of the drawings are not necessarily depicted to scale, since emphasis is placed upon clearly illustrating the elements and structures of the present embodiments.

In the following description, similar features in the drawings have been given similar reference numerals, and in order not to weigh down the figures, some elements are not referred to in some figures if they were already identified in a precedent figure. Herein, it shall further be noted that, for avoiding unnecessary details obscuring the invention, only device structures and/or processing steps closely relevant to schemes according to the invention are shown in the accompanying drawings while omitting other details less relevant to the invention.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, un-recited elements.

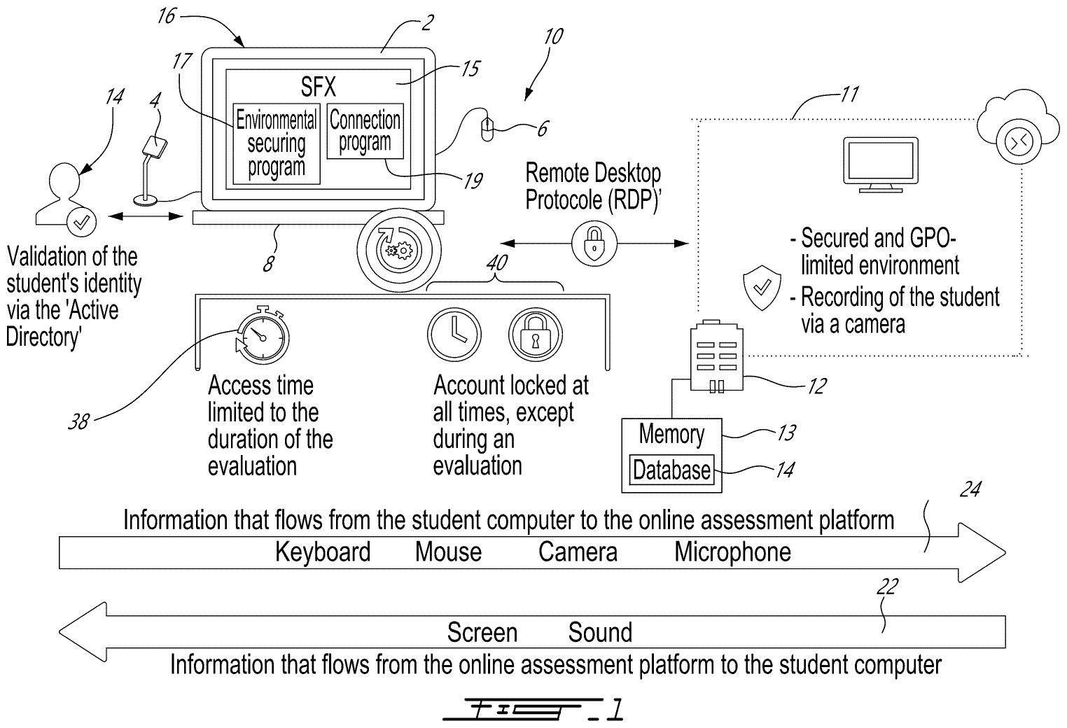

With references to FIG. 1, a system 10 for secure online evaluation according to an illustrative embodiment will now be described.

According to the first illustrative embodiment, the system 10 is adapted for the Windows™ environment.

The system 10 includes a secure server 12 having access to at least one memory 13 that has stored therein a) a database 14 including information about students, and b) one or more evaluations for the students (not shown).

The at least one memory includes, for example, a first memory having stored therein information about students and a second memory having stored therein one or more evaluations. According to another illustrative embodiment, a single memory is provided to store both the student information and the evaluation(s).

Also, the memory(ies) can be made accessible through one or more server (not shown).

As will be described hereinbelow in more detail, a file 15 is provided to the student to run on its computer 16, which allows a secured and GPO (Group Policy Object)-limited session 11 on the server 12 that allows the student access to the evaluation and to respond thereto.

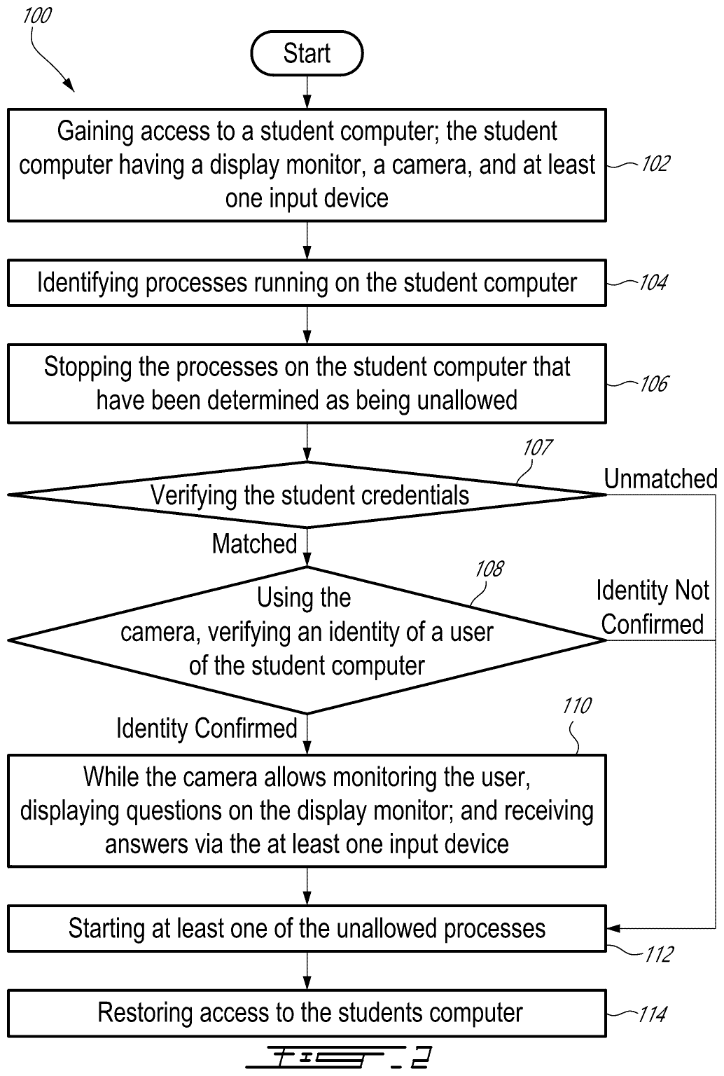

With references to FIGS. 1 and 2, illustrative embodiments of a system 10 and a computer-implemented method 100, both for allowing an online student assessment, will now be described.

The first step 102 of the method 100 includes the server 12 gaining access to the computer 16 of each student participating to the assessment. The student computer 16 includes an output device, in the form of a display monitor 2, a camera 4 and input devices, in the form of a mouse 6 and a keyboard 8.

This is achieved by each student executing on its computer 12 a compressed self-extracting computer executable program (SFX) 15 that has been acquired by the student previously to the assessment, for example when registering to the assessment via a web site. Such a web site can be hosted on the server 12 or on another server operatively coupled to the server 12.

According to another illustrative embodiment, the self-extracting computer executable program is provided on a portable USB drive or the like.

The compressed SFX 15 contained computer-executable instructions, which first uncompressed further instructions which are executed on the student computer 16. These further instructions extract 1) an environment-securing program 17, and 2) a connection program 19. As well known in the art, a compressed self-extracting file does not require a further file compression application.

According to another illustrative embodiment, the SFX 15 is not compressed. Also, according to still another illustrative embodiment, the computer-executable instructions are provided as an already extracted executable file.

During the execution of the SFX 15, the environment-securing program 17, and the connection program 19 are extracted as hidden files in a hidden directory created during the extraction. Hiding the extracted files aims i) at easing the access to the assessment by the student, and ii) preventing the student from tempering with these files.

According to another illustrative embodiment, the environment-securing and connection programs are made visible by the SFX 15.

After the extraction process, the environment-securing program 17 is executed by the SFX 15.

According to the first illustrative embodiment, the environment-securing program 17 is in the form of an encrypted VBS (Virtual Basic Script) script that converts into a VBE (Visual Basic Encoded) script on the student computer.

More specifically, the execution of the VBE script, which leaves no visible trace on the student monitor 2, open Windows Task Manager in hidden mode and identifies all running Windows processes (step 104).

Among its functions, the VBE script performs a forced shutdown of processes that are determined to be unallowed to yield the secured and GPO-limited secure environment desired during the evaluation (step 106 in FIG. 2). Examples of such unallowed processes include, without limitations:

| | |
|---|---|
| explorer.exe | chrome.exe |
| firefox.exe | iexplore.exe |
| edge | msedge.exe |
| winword.exe | acroRd32.exe |
| wordpad.exe | notepad.exe |
| excel.exe | msaccess.exe |
| Taskmgr.exe | vlc.exe |
| screenrecorder.exe | videoeditor.exe |
| videocapture.exe | screencast-o-matic.exe |
| obs64.exe | screenrec.exe |
| bdcam.exe | teams.exe |
| zoom.exe | flashBack recorder.exe |
| online screen recorder.exe | cmd.exe |
| powershell.exe | |

The list of unallowed processes can be adapted according, for example, to the environment provided for a particular evaluation and vulnerabilities discovered.

According to a more specific embodiment, steps 104 and 106 of the method 100 are periodically repeated, for example about every 0.5 second.

According to another illustrative embodiment, steps 104 and 106 from the method 100 are repeated un-periodically, or according to another frequency than about every 0.5 second.

The environment-securing program 17 is not limited to a VBE script, and can be, for example, a VBS script, another other compiled or uncompiled instructions set, or any other scripting tool or program configured for automatically interacting with the operating system.

After the shutdown of the unallowed processes, the environment-securing script 17 launches the execution of the connection program 19.

A first step of the connection program 19 is to start a remote computing session by executing the well-known Windows™ process ‘mstsc.exe’, which is the ‘Microsoft Terminal Services Client’, commonly known as Remote Desktop Connection (RDC), which initiates a connection with the server 12.

The connection program 19 is configured to monitor the operation of RDC, and if it is determined that it is stopped, it restarts the ‘explorer.exe’ process.

Under the Remote Desktop Protocol (RDP), the connection program 19 creates a client-server connection between the student computer 16 and server 12.

The first step in establishing the connection includes prompting the student, via a dialog box (not shown), whether the student wishes to allow a connection with the server 12.

If the student refuses, then the connection program 19 restarts the ‘explorer.exe’ process (step 112 in FIG. 2), thereby giving back to the student the access to its computer 16 (step 114 in FIG. 2).

According to another illustrative embodiment, such initial prompting of the student is achieved using another computer interaction tool than a dialog box, or is omitted.

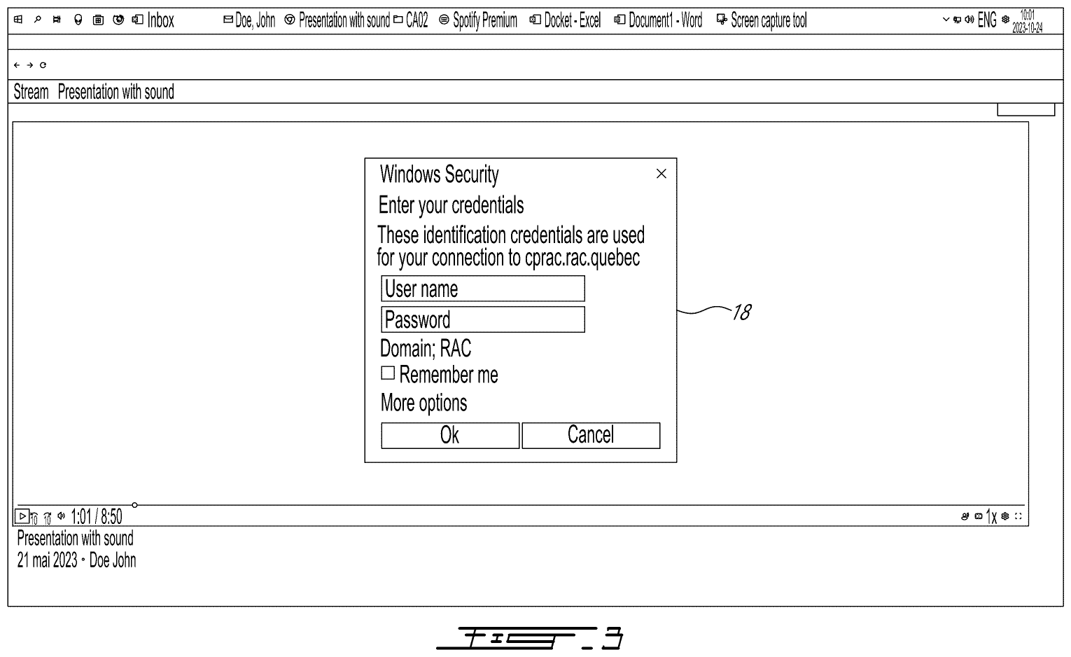

If the student agrees to the connection with the server 12, then the connection program prompts the student, via a computer interaction tool, such as dialog box 18 (see on FIG. 3), to enter their credentials (step 107 in FIG. 1).

With reference to FIG. 3, it is to be noted that, before the client-server connection, the GUI displayed on the student monitor 2 is still from the well-known Windows™ environment, according to the own student settings, and therefore at this point within the control of the student.

The student credentials are validated using an Active Directory (AD) 14 on the server 12.

According to another illustrative embodiment, the student credentials are validated using another type or form of databases than the Active Directory 14.

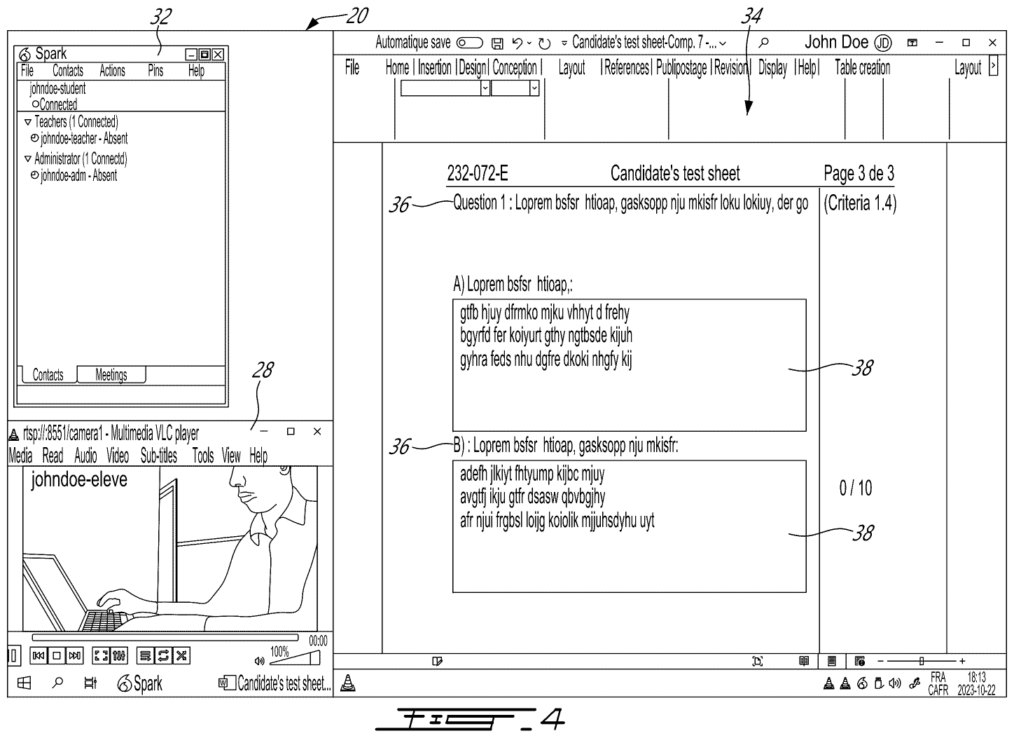

As illustrated in FIG. 4, once the credentials are validated, an assessment GUI 20 is pushed from the server 12 to replace parts or all of the students regular Windows™ environment.

A person skilled in the art will appreciate from the above that the operational state of the computer 16 is modified, first by the environment-securing program 17 to prevent processes from running, and then by the connection program 19, which establishes a client-server link with the server 12.

Turning briefly to FIG. 1, the client is configured for:
monopolizing the use of all of the student display monitor(s) 2 and of any other output device (see reference numeral 22 in FIG. 1);
monopolizing the output of the camera 4, microphone, keyboard 8 and of any other output device connected to the student's computer (see 24 in FIG. 1);
disabling the toolbar of the Remote Desktop toolbar; and
forcing the use of the Remote Desktop Protocol (RDP).

According to the first illustrative embodiment, the microphone on the student computer 16 is part of the camera 4. According to another illustrative embodiment (not shown), the microphone is provided as a component that is separate from the camera 4.

Returning now to FIG. 2, the computer-implemented method 100 for online student assessment includes the further verification of the identity of the students by a remote supervisor (not shown) (step 108), as will now be described in more detail.

After the credentials of a student have been verified, the student Windows™ Desktop is replaced by the secure and GPO-limited environment.

A test of the student's computer environment is performed, which includes the server 12 verifying the operation of the camera 4 and microphone and pushing instructions on the student computer 16 to guide the student in preparing its environment. Such instructions, which can be for example in text, sound and/or in graphical form, guide the student in correctly positioning its camera 4 and adjusting the sound volume.

The video feed and sound feed 26 from the student computer 16 are then recorded on the server 12 from that point and until the end of the evaluation. Such a test is part of step 108 in FIG. 2, which further includes pushing instructions on the student computer 16 asking the student to show to the camera an ID card.

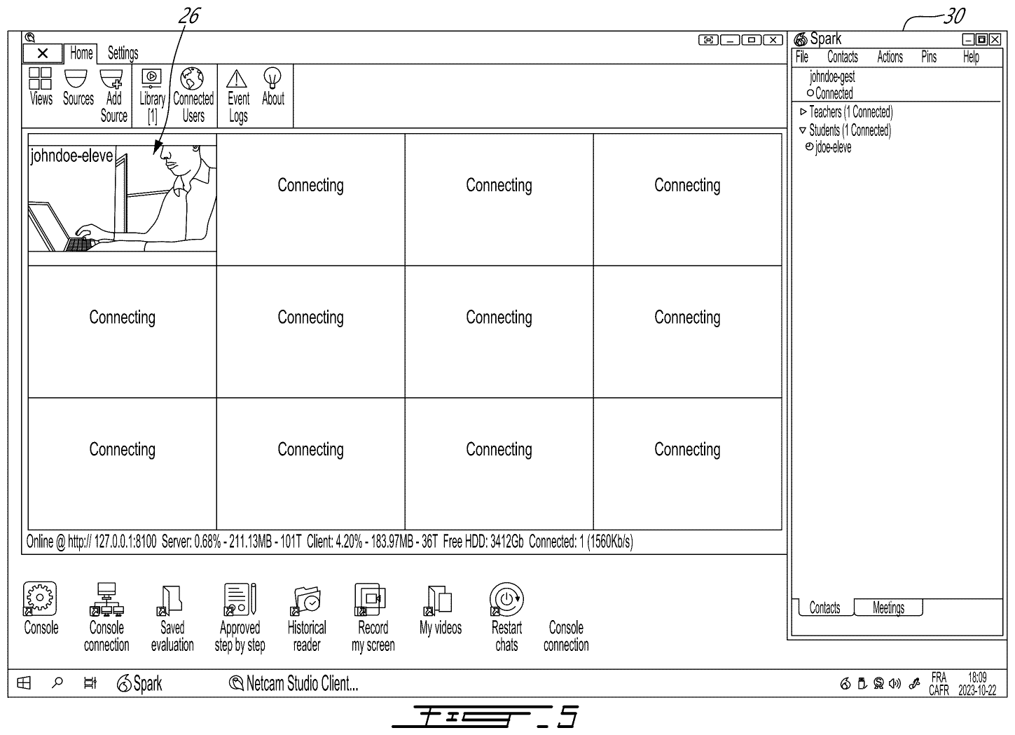

The server 12 yields access, via a GUI 30 (see FIG. 5), to a supervisor or to any remote person being granted access thereto, to the video and sound feed 26 from all students, during or after the evaluation. The assessment GUI 20 also allows the permanent or selective display of the student's own video feed in a dedicated window 28.

According to the illustrative embodiment, both the supervisor and the students have access to instant messaging through respective dedicated windows 30 and 32, the supervisor being allowed through the server 12 to communicate with all students and with any allowed third party (not shown), such as a teacher or manager, while the students are allowed to communicate only with the supervisor and the teacher.

The use of instant messaging is not limited to the above given example and different permission/access can be provided to each user of the system 10. For example, in a case where the assessment is a team collaboration, some students may be allowed to communicate with other selected students verbally, or via text messaging.

According to the first illustrative embodiment, instant messaging is integrated by the server in the assessment GUI 20 via a well-known instant messaging application, such as Spark™ or the like.

According to another illustrative embodiment, the system 10 does not allow instant messaging.

The assessment GUI 20 further includes a window 34, where the interactive evaluation is displayed. This interactive GUI 34 is provided by the server 12 and can be adapted to display questions in many forms, including text, clicking menu, multimedia, etc., and received answers thereto via the mouse 6, keyboard 8, or via other input devices connected or part of the computer 16.

With reference more specifically to FIG. 4, the GUI 34 includes a questionnaire in text form created by the well-known Microsoft Word™ text editor, and includes a series of questions 36, each followed by a text-receiving box 38 to enter the answer.

According to another illustrative embodiment, any other well-known response capture tools can be provided instead or in addition to the text-receiving box 38.

Returning to FIG. 2, each student responds to the questionnaire while having their camera continuously monitoring their actions (step 110). As described hereinabove, the supervisor, having access to the video feeds 26 and sound feeds of all the cameras 4, may choose to monitor one or a plurality of the students at any given time during the evaluation.

The answers to the questionnaire of each student participating in the online assessment are saved in real time on the server 12. According to another illustrative embodiment, the answers are sent to the server 12 following an action of the student using the assessment GUI 20 or retrieved periodically or following an action by a supervisor via the server 12.

The server 12 may be configured to save all the video and sound feeds for future references. According to a more specific embodiment, the server 12 is configured with well-known tools to time synchronized the feeds and the answers entered by the student. Since such synchronizing tools are believed to be well known in the art, they will not be described herein in more detail for concision purposes.

Also, the server 12 may be configured to either allow the students to perform an evaluation at different times or all at a same time.

With reference more specifically to FIG. 1, the server 12 can be configured to grant access to the student to the questionnaire for a limited time (see 38 in FIG. 1), the assessment cession being closed at the end of such limited time and the ‘explorer.exe’ process being restarted (step 112), restoring full access to the students to their computers 16 (step 114).

As illustrated in FIG. 1, the server 12 is configured with tools that allow to create and manage a database 14 stored in a memory 13, including, without limitations, students' accounts information and each student's answers to current and/or past questionnaires. Such student's accounts being always locked, except when criteria are met, such as, for example, during the time of an evaluation (see 40 in FIG. 1).

Since user account securing, managing and accessing tools are well known in the art, they will not be described herein in more detail for concision purposes.

It is believed to be within the reach of a person skilled in the art to configure the server 12 with one or more programs adapted to perform the various tasks thereof, as described hereinabove. Since such programs are believed to be well known in the art, they will not be described herein in more detail for concision purposes.

While the system 10 and method 100 have been described hereinabove, in some instance, with reference to one student, it is understood from the above that the system 10 and method 100 allow a plurality of students to simultaneously participate in a same evaluation.

It is to be noted that many modifications could be made to the system 10 and method 100 described hereinabove and illustrated in the appended drawings. For example:
while the system 10 is adapted to the Microsoft Windows™ environment, it is believed to be within the reach of a person skilled in the art to adapt the system 10 to another environment or to make it function on a plurality of environments;
the expression “student computer” is not limited to any specific embodiment, and should be construed to include any “information processing apparatus”;
the supervisor is not limited to a human being and can alternatively or additionally be an artificial intelligence capable of face recognition and further adapted to interact with the students verbally or through text.

Although a method and system for secure online assessment are described hereinabove by way of illustrated embodiments thereof, they can be modified. It is therefore to be understood that numerous modifications may be made to the illustrative embodiments and that the scope of the claims should not be limited by the preferred embodiment but should be given the broadest interpretation consistent with the description as a whole.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A computer-implemented method for an online student assessment comprising:
using a server for:
i) gaining access to a student information processing apparatus; the information processing apparatus comprising at least one output device, a camera, and at least one input device;
ii) identifying processes running on the information processing apparatus;
iii) among the processes running on the information processing apparatus, stopping processes determined to be unallowed during the online student assessment;
iv) verifying an identity of a user of the information processing apparatus;
v) if the identity of the user is confirmed then, while remotely monitoring the user via the camera, providing questions on the at least one output device, and receiving answers via the at least one input device;
vi) restarting at least one of the unallowed processes; and
vii) restoring access to the information processing apparatus.

2. The computer-implemented method as recited in claim 1, wherein the method further comprising running a program on the student information processing apparatus resulting in at least one of i) to vii).

3. The computer-implemented method as recited in claim 2, wherein the program includes an environment-securing subprogram, which causes at least one of i) to iv) and a connection subprogram, which causes at least one of v) to vi).

4. The computer-implemented method as recited in claim 3, wherein the program is a self-extracting executable program and at least one of the environment-securing subprogram and the connection subprogram is extracted as hidden files.

5. The computer-implemented method as recited in claim 3, wherein the connection subprogram initiates a remote connection with the server.

6. The computer-implemented method as recited in claim 5, wherein the connection subprogram further monitors the remote connection, forcing vi) and vii) when the remote connection is determined by the connection subprogram as being stopped.

7. The computer-implemented method as recited in claim 5, wherein the connection subprogram first prompts the user of the information processing apparatus to first agree to the remote connection with the server before said initiating a remote connection with the server.

8. The computer-implemented method as recited in claim 1, wherein verifying an identity of a user of the information processing apparatus further comprising the server accessing and using student-related information.

9. The computer-implemented method as recited in claim 1, wherein ii) and iii) are both repeated during v).

10. The computer-implemented method as recited in claim 1, wherein at least one of 1) said verifying an identity of a user of the information processing apparatus, and 2) monitoring the user via the camera, includes the server granting access to the camera to a remote supervisor via a supervising information processing apparatus.

11. The computer-implemented method as recited in claim 1, wherein said providing questions on the at least one output device and said receiving answers being allowed for a limited time by the server.

12. A system for providing an online student assessment comprising:
a server having access to at least one computer-readable memory having recorded thereon at least one student evaluation; the server being configured for gaining access to at least one information processing apparatus via instructions for execution on the at least one information processing apparatus; the at least one information processing apparatus including at least one output device, a camera, and at least one input device; said instructions being for:
i) identifying processes running on the at least one information processing apparatus;
ii) among the processes running on the at least one information processing apparatus, stopping processes determined to be unallowed during the online student assessment;
iii) verifying an identity of a user of the at least one information processing apparatus using the camera;
iv) if the identity of the user is confirmed then, while remotely monitoring the user via the camera, providing questions on the at least one output device, and receiving answers via the at least one input device;
v) restarting at least one of the unallowed processes; and
vi) restoring access to the at least one information processing apparatus.

13. The system as recited in claim 12, wherein the server being configured to allow access to instant messaging to the at least one information processing apparatus.

14. The system as recited in claim 12, wherein the instructions for execution on the at least one information processing apparatus yields a policy-restricted session thereon.

15. The system as recited in claim 12, wherein the at least one computer-readable memory further having recorded thereon information about at least one student; wherein verifying an identity of a user of the at least one information processing apparatus further comprising using the information about at least one student.

16. The system as recited in claim 12, wherein said providing questions on the at least one output device, and receiving answers via the at least one input device is achieved via a GUI (Graphical User Interface) pushed by the server to the at least one information processing apparatus.

17. The system as recited in claim 12, wherein the instructions are further to cause the server to assume control of the at least one input device and of the at least one output device.

18. The system as recited in claim 12, further comprising a supervising information processing apparatus that accesses a feed of the camera via the server for at least one of 1) said verifying an identity of a user of the at least one information processing apparatus, and 2) said remotely monitoring the user.

19. The system as recited in claim 12, wherein the server being configured for storing on the at least one computer-readable memory a feed of the camera of the at least one information processing apparatus during at least one of steps iii) and iv).

20. A non-transitory computer-readable medium having recorded thereon instructions for execution by an information processing apparatus equipped with at least one output device, a camera, and at least one input device; the instructions being for:
identifying processes running on the information processing apparatus;
stopping the processes running on the information processing apparatus that have been determined as being unallowed;
allowing a remote device to use the camera, and to access information about the students to verify an identity of a user of the information processing apparatus;
if the identity of the user is confirmed then, while remotely monitoring the user via the camera, providing questions on the at least one output device and receiving answers via the at least one input device;
restarting at least one of the unallowed processes; and
restoring access to the information processing apparatus.
